(19) United States
(12) Patent Application Publication
(10) Pub. No.: US 2025/0191843 A1
(43) Pub. Date: Jun. 12, 2025

(54) MULTILAYER CERAMIC CAPACITOR

(71) Applicant: Murata Manufacturing Co., Ltd., Nagaokakyo-shi (JP)

(72) Inventors: Kazuhiko HIGASHIDE, Nagaokakyo-shi (JP); Shinji OTANI, Nagaokakyo-shi (JP); Daichi TANIGUCHI, Nagaokakyo-shi (JP); Shinya ISOTA, Nagaokakyo-shi (JP)

(21) Appl. No.: 19/058,280

(22) Filed: Feb. 20, 2025

Related U.S. Application Data
(63) Continuation of application No. PCT/JP2023/037847, filed on Oct. 19, 2023.

(30) Foreign Application Priority Data
Nov. 24, 2022 (JP) 2022-187611

(51) Int. Cl. H01G 4/232; H01G 4/008; H01G 4/012; H01G 4/12; H01G 4/30

(52) U.S. Cl. CPC H01G 4/232; H01G 4/008; H01G 4/012; H01G 4/1209; H01G 4/30

(57) ABSTRACT

In a multilayer ceramic capacitor, in a dielectric in a side surface outer layer portion, a content ratio Ba/(Ti+Zr) is about 0.995 or more and about 1.003 or less, and a content of Mg is about 0.5 to about 5.0 parts by mol larger than that in a dielectric at a center portion, or a content of Mn is about 0.4 to about 2.0 parts by mol larger than that in the dielectric at the center portion, and in a dielectric in an end surface outer layer portion, a content ratio Ba/(Ti+Zr) is about 0.995 or more and about 1.003 or less, and a content of Mg is about 0.25 to about 2.5 parts by mol larger than that in the dielectric at the center portion, or a content of Mn is about 0.2 to about 1.0 parts by mol larger than that in the dielectric at the center portion.

### CROSS REFERENCE TO RELATED APPLICATIONS

This application claims the benefit of priority to Japanese Patent Application No. 2022-187611 filed on Nov. 24, 2022 and is a Continuation Application of PCT Application No. PCT/JP2023/037847 filed on Oct. 19, 2023. The entire contents of each application are hereby incorporated herein by reference.

### BACKGROUND OF THE INVENTION

### 1. Field of the Invention

The present invention relates to multilayer ceramic capacitors.

### 2. Description of the Related Art

In general, a multilayer ceramic capacitor includes a multilayer body formed by laminating a plurality of dielectric layers and a plurality of internal electrode layers, and outer electrodes disposed at predetermined positions of the multilayer body to be electrically connected to the internal electrode layers. A main region of the multilayer body includes an effective portion in which the internal electrode layers overlap each other to generate a capacitance, outer layer portions (hereinafter referred to as “main surface side outer layer portions”) disposed with the effective portion interposed therebetween in a lamination direction, outer layer portions (hereinafter referred to as “side surface side outer layer portions”) disposed with the effective portion interposed therebetween in a width direction intersecting the lamination direction, outer layer portions (hereinafter referred to as “end surface side outer layer portions”) disposed with the effective portion interposed therebetween in a length direction intersecting the lamination direction and the width direction, and outer layer portions (hereinafter referred to as “corner side outer layer portions”) that are disposed at four corners of the multilayer body in plan view to each couple the side surface side outer layer portion and the end surface side outer layer portion.

The multilayer body is formed through a sintering step, but when the conditions of the sintering step are suitable for the effective portion, each of the above-described outer layer portions is likely to have grain growth of a dielectric and spaces between the grains. Such grain growth (increasing sintered particle size) makes the insulation resistance more likely to vary, and voids between the grains become paths for moisture to infiltrate from the outside. In particular, voids generated in the side surface side outer layer portion or the end surface side outer layer portion form paths for moisture to reach the effective portion, thus reducing the moisture resistance reliability of the multilayer ceramic capacitor.

Therefore, it is required to develop a multilayer ceramic capacitor in which a dense dielectric is formed in a predetermined region of a side surface side outer layer portion and the like to prevent infiltration of moisture from the outside and improve moisture resistance reliability.

### SUMMARY OF THE INVENTION

Example embodiments of the present invention provide multilayer ceramic capacitors each with high moisture resistance reliability by providing a dense dielectric in a predetermined region of a side surface side outer layer portion and the like of the multilayer body to prevent infiltration of moisture from the outside.

The inventors of example embodiments of the present invention have discovered that, when a dielectric layer of a multilayer ceramic capacitor includes Ba, Ti, and Zr, and Mg or Mn, by adjusting a content ratio of Ba, Ti, and Zr and a content of Mg or Mn in a predetermined region of a side surface side outer layer portion and the like, a dense dielectric is provided, and the moisture resistance reliability of the multilayer ceramic capacitor is improved.

An example embodiment of the present invention provides a multilayer ceramic capacitor including a multilayer body including a plurality of dielectric layers and a plurality of internal electrode layers that are laminated, and an outer electrode to be electrically connected to the plurality of internal electrode layers, in which the dielectric layers include Ba, Ti, and Zr, and Mg or Mn, the multilayer body includes a first main surface and a second main surface opposite to each other in a lamination direction of the dielectric layers and the plurality of internal electrode layers, a first side surface and a second side surface opposite to each other in a width direction intersecting both the lamination direction and a length direction in which the plurality of internal electrode layers extend to the outer electrode, and a first end surface and a second end surface opposite to each other in the length direction, the outer electrode is provided on each of the first end surface and the second end surface, in the multilayer body, a region in which internal electrode layers overlap each other as viewed in the lamination direction is defined as an effective portion, regions opposite to each other in the lamination direction with the effective portion therebetween are defined as a first main surface side outer layer portion and a second main surface side outer layer portion, regions opposite to each other in the width direction with the effective portion therebetween are defined as a first side surface side outer layer portion and a second side surface side outer layer portion, and regions opposite to each other in the length direction with the effective portion therebetween are defined as a first end surface side outer layer portion and a second end surface side outer layer portion, at a center portion of the first side surface side outer layer portion or the second side surface side outer layer portion in the length direction, in a dielectric in a region between the first side surface or the second side surface and one of the internal electrode layers, Ba/(Ti+Zr), which is a content ratio of Ba, Ti, and Zr, is about 0.995 or more and about 1.003 or less, and a content of Mg relative to 100 parts by mol of Ti is about 0.5 parts by mol to about 5.0 parts by mol larger than a content of Mg relative to 100 parts by mol of Ti in a dielectric which is in a region at a center portion in the width direction and the length direction of the multilayer body, or a content of Mn relative to 100 parts by mol of Ti is about 0.4 parts by mol to about 2.0 parts by mol larger than a content of Mn relative to 100 parts by mol of Ti in the effective portion at the center portion in the width direction and the length direction, in the first end surface side outer layer portion or the second end surface side outer layer portion, in a dielectric in a region between the first end surface or the second end surface and one of the internal electrode layers, Ba/(Ti+Zr), which is a content ratio of Ba, Ti, and Zr, is about 0.995 or more and about 1.003 or less, and a content of Mg relative to 100 parts by mol of Ti is about 0.25 parts by mol to about 2.5 parts by mol larger than the content of Mg relative to 100 parts by mol of Ti in the effective portion at the center portion in the width direction and the length direction, or a content of Mn relative to 100 parts by mol of Ti is about 0.2 parts by mol to about 1.0 parts by mol larger than the content of Mn relative to 100 parts by mol of Ti in the dielectric which is in the region at the center portion in the width direction and the length direction of the multilayer body.

According to example embodiments of the present invention, multilayer ceramic capacitors each with high moisture resistance reliability are provided and include a dense dielectric in a predetermined region of a side surface side outer layer portion and the like of the multilayer body to prevent infiltration of moisture from the outside.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a multilayer ceramic capacitor according to an example embodiment of the present invention.

FIG. 2 is a sectional view of the multilayer ceramic capacitor taken along line I-I shown in FIG. 1.

FIG. 3 is a sectional view of the multilayer ceramic capacitor taken along line II-II shown in FIG. 2.

FIG. 4 is a sectional view of the multilayer ceramic capacitor taken along line III-III shown in FIG. 2.

FIG. 5 is a sectional view of the multilayer ceramic capacitor taken along line IV-IV shown in FIG. 1.

FIG. 6 is a sectional view of the multilayer ceramic capacitor taken along line V-V shown in FIG. 2.

FIG. 7 is a partially enlarged view showing a vicinity of a terminal in a width direction W of an internal electrode layer shown in FIG. 5.

### DETAILED DESCRIPTION OF THE EXAMPLE EMBODIMENTS

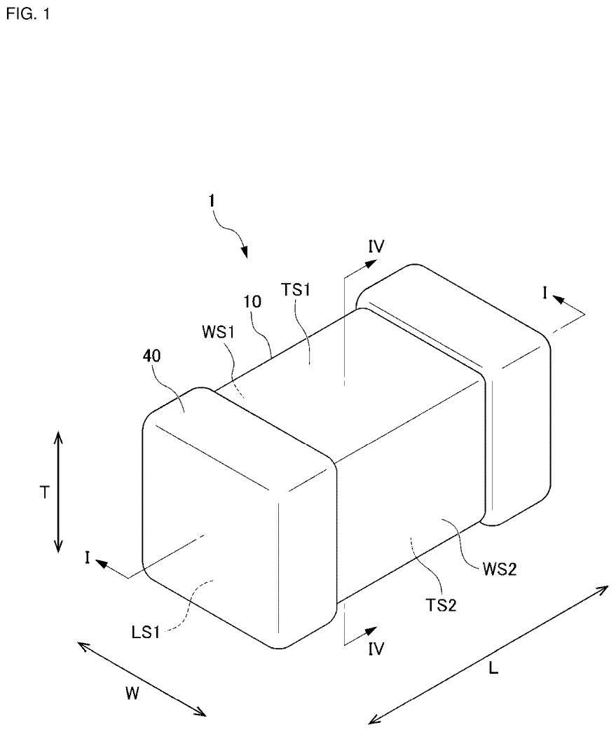

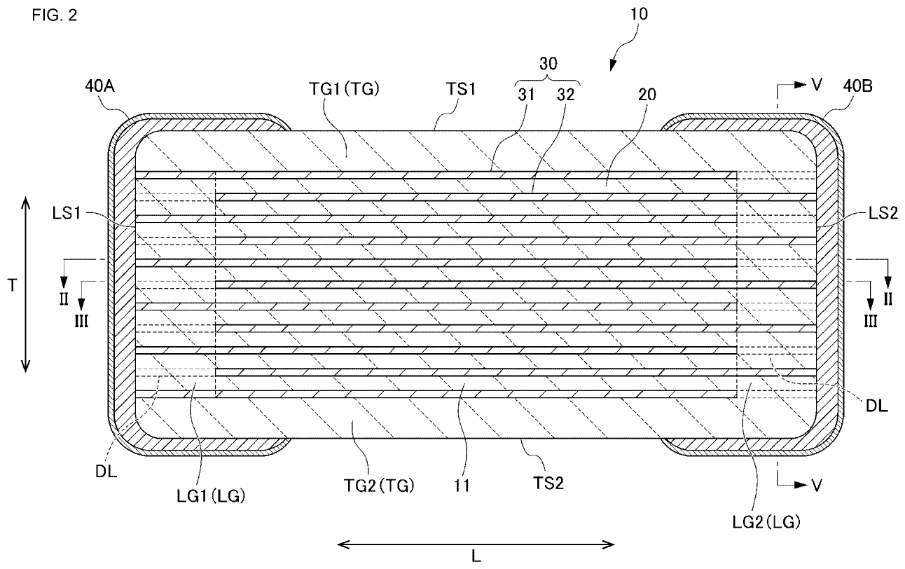

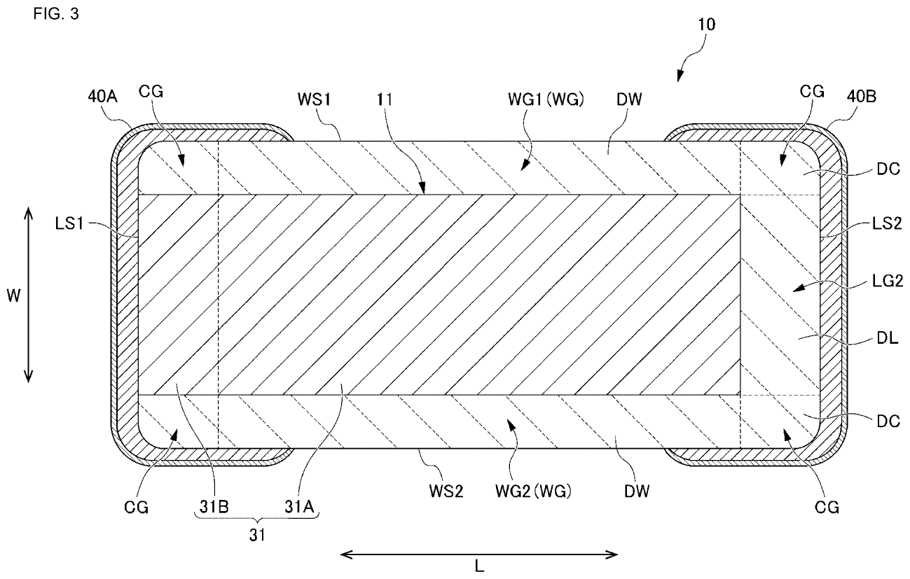

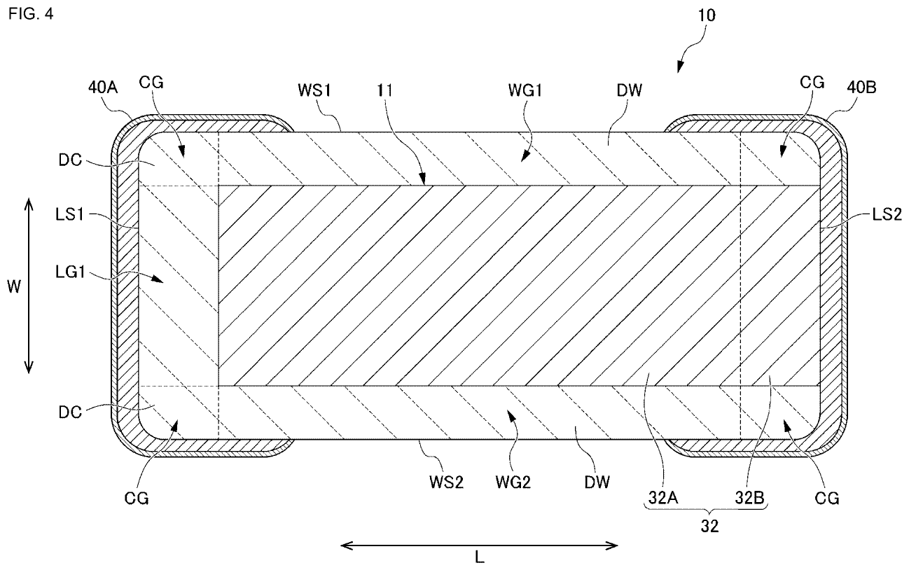

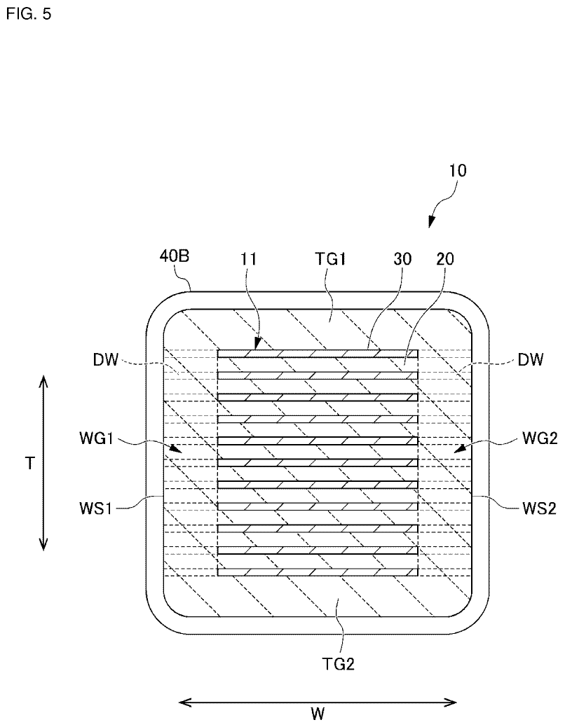

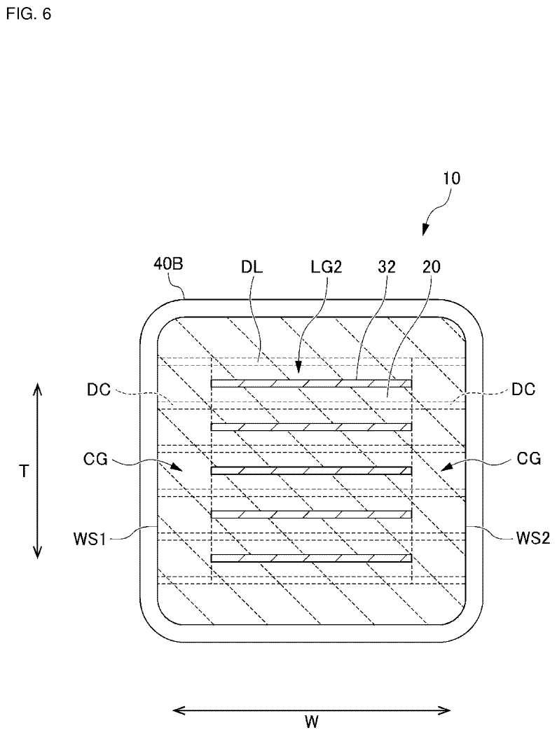

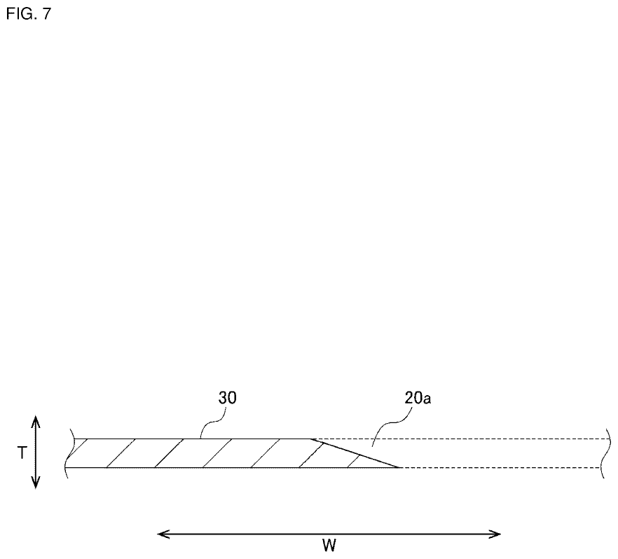

Hereinafter, example embodiments of the present invention will be described with reference to the drawings. FIG. 1 is a schematic perspective view of a multilayer ceramic capacitor 1 according to an example embodiment. FIG. 2 is a sectional view of the multilayer ceramic capacitor 1 taken along line I-I shown in FIG. 1. FIG. 3 is a sectional view of the multilayer ceramic capacitor 1 taken along line II-II shown in FIG. 2. FIG. 4 is a sectional view of the multilayer ceramic capacitor 1 taken along line III-III shown in FIG. 2. FIG. 5 is a sectional view of the multilayer ceramic capacitor 1 taken along line IV-IV shown in FIG. 1. FIG. 6 is a sectional view of the multilayer ceramic capacitor 1 taken along line V-V shown in FIG. 2. FIG. 7 is a partially enlarged view showing a vicinity of a terminal in a width direction W of an internal electrode layer shown in FIG. 5. Note that line I-I passes through a center portion of the multilayer ceramic capacitor 1 in the width direction W, which will be described later, and line IV-IV passes through a center portion of the multilayer ceramic capacitor 1 in a length direction L, which will be described later.

In the following description, a direction in which a pair of outer electrodes 40 are provided is referred to as the length direction L, as a term representing the orientation of the multilayer ceramic capacitor 1. A direction in which a dielectric layer 20 and an internal electrode layer 30 are laminated is referred to as a lamination direction T. A direction intersecting both the length direction L and the lamination direction T is referred to as the width direction W. In the present example embodiment, the length direction L, the lamination direction T, and the width direction W are orthogonal or substantially orthogonal to each other. In addition, the cross section shown in FIG. 2 is also referred to as an LT cross section. The cross sections shown in FIGS. 3 and 4 are also referred to as LW cross sections. The cross sections shown in FIGS. 5 and 6 are also referred to as WT cross sections.

### Multilayer Ceramic Capacitor

The multilayer ceramic capacitor 1 includes a multilayer body 10 provided by laminating a plurality of dielectric layers 20 and a plurality of internal electrode layers 30, and the pair of outer electrodes 40 provided at respective ends of the multilayer body 10.

### Multilayer Body

The multilayer body 10 has a rectangular or substantially rectangular parallelepiped shape. Corner portions and ridge line portions of the multilayer body 10 are preferably rounded. The corner portion is a portion where three surfaces of the multilayer body intersect each other, and the ridge line portion is a portion where two surfaces of the multilayer body intersect each other. The dimension of the multilayer body 10 in the length direction L is not always larger than the dimension in the width direction W. In addition, unevenness or the like may be provided at a portion or the entirety of the surface constituting the multilayer body 10.

The dimensions of the multilayer body 10 are not particularly limited, but, for example, when the dimension of the multilayer body 10 in the length direction L is defined as an L dimension, the L dimension is preferably about 0.2 mm or more and about 10 mm or less. In addition, for example, when a dimension of the multilayer body 10 in the lamination direction T is defined as a T dimension, the T dimension is preferably about 0.1 mm or more and about 10 mm or less. In addition, for example, when a dimension of the multilayer body 10 in the width direction W is defined as a W dimension, the W dimension is preferably about 0.1 mm or more and about 10 mm or less.

As shown in FIGS. 1 and 2, the multilayer body 10 includes a first main surface TS1 and a second main surface TS2 which are opposite to each other in the lamination direction T, a first side surface WS1 and a second side surface WS2 which are opposite to each other in the width direction W intersecting the lamination direction T, and a first end surface LS1 and a second end surface LS2 which are opposite to each other in the length direction L intersecting the lamination direction T and the width direction W.

### Dielectric Layer

The plurality of dielectric layers 20 laminated in the multilayer body 10 each include a plurality of ceramic particles including Ba and Ti. The ceramic particles are, for example, crystal particles of a perovskite-type compound represented by general formula AₘBO₃ (A is Ba, B is Ti, Zr can be included in addition to Ti, O is oxygen, and m is a molar ratio of A and B).

The dielectric layer 20 includes Zr as a subcomponent in the perovskite-type compound which is a main component. The structure of Zr in the dielectric layer 20 is not particularly limited. For example, a structure in which Zr exists inside the crystal particles of a perovskite-type compound and a core and a shell are not clearly distinguished from each other may be used. Alternatively, for example, a structure in which ceramic particles are configured by a core portion including a perovskite-type compound including Ba and Ti and a shell portion provided by Zr being solid-solubilized in the periphery of the core portion may be used.

In addition, for example, the dielectric layer 20 includes Mg or Mn as a subcomponent in the perovskite-type compound which is a main component. The structure of Mg or Mn in the dielectric layer 20 is not particularly limited. For example, a structure in which Mg or Mn is solid-solubilized inside the crystal particles of the perovskite-type compound and a core and a shell are not clearly distinguished from each other may be used. Alternatively, for example, a structure in which ceramic particles are configured by a core portion consisting of a perovskite-type compound including Ba and Ti and a shell portion provided by Mg or Mn being solid-solubilized in the periphery of the core portion may be adopted. In addition, for example, the subcomponent may include RE (Y, La, Sm, Eu, Gd, Tb, Dy, Ho, Er, Tm, or Yb), Si, Ni, V, Al, or the like together with Mg or Mn.

The thickness of the dielectric layer 20 is, for example, preferably about 0.5 μm or more and about 72 μm or less. The number of dielectric layers 20 to be laminated is, for example, preferably 10 or more and 700 or less. The number of the dielectric layers 20 is the total number of the number of dielectric layers of the effective portion 11 and the number of dielectric layers of a first main surface side outer layer portion TG1 and a second main surface side outer layer portion TG2.

### Internal Electrode Layer

The plurality of internal electrode layers 30 laminated in the multilayer body 10 include a first internal electrode layer 31 and a second internal electrode layer 32. A plurality of first internal electrode layers 31 are disposed on the plurality of dielectric layers 20. A plurality of second internal electrode layers 32 are disposed on the plurality of dielectric layers 20. The plurality of first internal electrode layers 31 and the plurality of second internal electrode layers 32 are alternately disposed in the lamination direction T of the multilayer body 10.

The first internal electrode layer 31 includes a first facing portion 31A facing the second internal electrode layer 32 and a first extended portion 31B extended from the first facing portion 31A to the first end surface LS1. The first extended portion 31B is exposed on the first end surface LS1.

The second internal electrode layer 32 includes a second facing portion 32A facing the first internal electrode layer 31 and a second extended portion 32B extended from the second facing portion 32A to the second end surface LS2. The second extended portion 32B is exposed on the second end surface LS2.

The first internal electrode layer 31 and the second internal electrode layer 32 are made of an appropriate conductive material such as, for example, a metal such as Ni, Cu, Ag, Pd, or Au, or an alloy including at least one of these metals. In the case of using an alloy, the first internal electrode layer 31 and the second internal electrode layer 32 may be made of, for example, an Ag—Pd alloy.

The thickness of each of the first internal electrode layer 31 and the second internal electrode layer 32 is, for example, preferably about 0.2 μm or more and about 3.0 μm or less. The total number of the first internal electrode layers 31 and the second internal electrode layers 32 is, for example, preferably 5 or more and 350 or less.

### Outer Electrode

The outer electrodes 40 include a first outer electrode 40A and a second outer electrode 40B.

The first outer electrode 40A is disposed on the first end surface LS1 side. The first outer electrode 40A is connected to the first internal electrode layers 31. The first outer electrode 40A is disposed on the first end surface LS1, but may be disposed on at least any one of the first main surface TS1, the second main surface TS2, the first side surface WS1, or the second side surface WS2, in addition to the first end surface LS1. In the present example embodiment, the first outer electrode 40A is disposed not only on the first end surface LS1 but also on a portion of the first main surface TS1, a portion of the second main surface TS2, a portion of the first side surface WS1, and a portion of the second side surface WS2. The first outer electrode 40A may be disposed, for example, from the first end surface LS1 to either the first main surface TS1 or the second main surface TS2. That is, the cross-sectional shape of the first outer electrode 40A may be L-shaped (not shown).

The second outer electrode 40B is disposed on the second end surface LS2 side. The second outer electrode 40B is connected to the second internal electrode layers 32. The second outer electrode 40B is disposed on the second end surface LS2, but may be disposed on at least any one of the first main surface TS1, the second main surface TS2, the first side surface WS1, or the second side surface WS2, in addition to the second end surface LS2. In the present example embodiment, the second outer electrode 40B is disposed on a portion of the first main surface TS1, a portion of the second main surface TS2, a portion of the first side surface WS1, and a portion of the second side surface WS2, in addition to the second end surface LS2. The second outer electrode 40B may be disposed, for example, from the second end surface LS2 to either the first main surface TS1 or the second main surface TS2. That is, the cross-sectional shape of the second outer electrode 40B may be L-shaped (not shown).

In the multilayer body 10, a capacitance is generated by the first facing portion 31A of the first internal electrode layer 31 and the second facing portion 32A of the second internal electrode layer 32 facing each other with the dielectric layer 20 interposed therebetween. Therefore, the function of the capacitor is provided between the first outer electrode 40A connected to the first internal electrode layers 31 and the second outer electrode 40B connected to the second internal electrode layers 32.

The first outer electrode 40A and the second outer electrode 40B can include, for example, a base electrode layer and a plating layer disposed on the base electrode layer. The base electrode layer is formed by applying a conductive paste including a metal component and a glass component to the first end surface LS1 and the second end surface LS2 of the multilayer body 10 and then baking the multilayer body 10. As the metal component blended in the conductive paste, for example, a metal such as Cu, Ni, Ag, Pd, Au, or an alloy of Ag and Pd and the like can be used.

The plating layer disposed on the base electrode layer includes, for example, at least one of a metal such as Cu, Ni, Ag, Pd, Au, or an alloy of Ag and Pd and the like. The plating layer can have, for example, a two-layer structure of a Ni plating layer and a Sn plating layer. However, the plating layer may include a single layer or a plurality of layers.

The multilayer body 10 includes, as a region of the multilayer body 10, an effective portion 11 in which internal electrode layers overlap each other to generate a capacitance, main surface side outer layer portions TG disposed with the effective portion 11 interposed therebetween in the lamination direction T, side surface side outer layer portions WG disposed with the effective portion 11 interposed therebetween in the width direction W intersecting the lamination direction T, and end surface side outer layer portions LG disposed with the effective portion 11 interposed therebetween in the length direction L intersecting the lamination direction T and the width direction W.

### Effective Portion

The effective portion 11 is a portion that generates an electrostatic capacitance and substantially defines and functions as a capacitor by the first facing portion 31A of the first internal electrode layer 31 and the second facing portion 32A of the second internal electrode layer 32 facing each other with the dielectric layer 20 interposed therebetween in the multilayer body 10.

As shown in FIG. 2, the multilayer body 10 includes the effective portion 11, and the first main surface side outer layer portion TG1 and the second main surface side outer layer portion TG2 that are disposed with the effective portion 11 interposed therebetween in the lamination direction T.

### Main Surface Side Outer Layer Portion

The first main surface side outer layer portion TG1 is positioned on the first main surface TS1 side of the multilayer body 10. The first main surface side outer layer portion TG1 can be formed by, for example, laminating the plurality of dielectric layers 20 as ceramic layers positioned between the first main surface TS1 and the internal electrode layer 30 closest to the first main surface TS1. The dielectric layer 20 used in the first main surface side outer layer portion TG1 may be the same or substantially the same as the dielectric layer 20 used in the effective portion 11.

The second main surface side outer layer portion TG2 is positioned on the second main surface TS2 side of the multilayer body 10. The second main surface side outer layer portion TG2 can be formed by, for example, laminating the plurality of dielectric layers 20 as ceramic layers positioned between the second main surface TS2 and the internal electrode layer 30 closest to the second main surface TS2. The dielectric layer 20 used in the second main surface side outer layer portion TG2 may be the same or substantially the same as the dielectric layer 20 used in the effective portion 11.

### Side Surface Side Outer Layer Portion

The side surface side outer layer portions WG include a first side surface side outer layer portion WG1 and a second side surface side outer layer portion WG2. The first side surface side outer layer portion WG1 is a portion including the dielectric layer 20 that is positioned between the effective portion 11 and the first side surface WS1. The second side surface side outer layer portion WG2 is a portion including the dielectric layer 20 that is positioned between the effective portion 11 and the second side surface WS2. FIG. 5 shows ranges of the first side surface side outer layer portion WG1 and the second side surface side outer layer portion WG2 in the WT cross section of the multilayer ceramic capacitor. The side surface side outer layer portion WG is also referred to as a W gap or a side gap.

### End Surface Side Outer Layer Portion

The end surface side outer layer portions LG include a first end surface side outer layer portion LG1 and a second end surface side outer layer portion LG2. The first end surface side outer layer portion LG1 is a portion including the dielectric layer 20 that is positioned between the effective portion 11 and the first end surface LS1. The second end surface side outer layer portion LG2 is a portion including the dielectric layer 20 that is positioned between the effective portion 11 and the second end surface LS2. FIG. 2 shows ranges of the first end surface side outer layer portion LG1 and the second end surface side outer layer portion LG2 in the LT cross section of the multilayer ceramic capacitor. The end surface side outer layer portion LG is also referred to as an L gap or an end gap.

### Region

In the first side surface side outer layer portion WG1 or the second side surface side outer layer portion WG2, there is a region DW between the first side surface WS1 or the second side surface WS2 and the internal electrode layer 30, as shown in FIG. 5. The region DW is likely to be a path through which moisture reaches the internal electrode layer 30 when moisture in the atmosphere has infiltrated into the inside of the multilayer body 10 from the first side surface WS1 or the second side surface WS2 of the multilayer body 10. In addition, in the first end surface side outer layer portion LG1 or the second end surface side outer layer portion LG2, there is a region DL between the first end surface LS1 or the second end surface LS2 and the internal electrode layer 30, as shown in FIG. 2. The region DL is likely to be a path through which moisture reaches the internal electrode layer 30 when moisture in the atmosphere has infiltrated into the inside of the multilayer body 10 from the first end surface LS1 or the second end surface LS2 of the multilayer body 10. Therefore, by increasing the density of the dielectric in the region DW and the region DL and reducing the gap between the grains, the infiltration of moisture into the internal electrode layer 30 can be reduced or prevented and the moisture resistance reliability of the multilayer ceramic capacitor can be improved.

### Moisture Resistance Reliability

Multilayer ceramic capacitors in which the content ratio (Ba/Ti+Zr) of Ba, Ti, and Zr in the dielectric in the region DW of the side surface side outer layer portion and the region DL of the end surface side outer layer portion and the content of Mg or Mn were different from each other were prepared as a sample, and a test for evaluating moisture resistance reliability was performed.

The content ratio (Ba/Ti+Zr) and the amount of increase in Mg or Mn were measured by performing element analysis by transmission electron microscope-energy dispersive X-ray spectroscopy (TEM-EDX) for the dielectrics in the region DW and the region DL. The amount of increase in Mg or Mn is an amount of increase with respect to the dielectric positioned at the center portion of the effective portion 11 in the width direction W and the length direction L, and is expressed as a numerical value obtained by converting the content of Ti into a content relative to 100 parts by mol. In addition, the content ratio (Ba/Ti+Zr) in the region DW of the side surface side outer layer portion and the content of Mg or Mn were measured at the center portion of the first side surface side outer layer portion WG1 or the second side surface side outer layer portion WG2 in the length direction L.

### Test Method

A moisture resistance load test was performed on 36 samples under conditions of about 125° C., a relative humidity of about 95%, a gauge pressure of about 0.1 MPa, and an applied voltage of about 4 V. A sample in which a logarithm Log IR of the insulation resistance was decreased by two digits from the start of the test was determined as a failure. The Weibull plot was performed, and it was determined that the average time to failure (MTTF) of less than about 72 hours was unacceptable (X) and the MTTF of about 72 hours or more was acceptable (0).

### Test Method for Densification

The end portion/side surface portion of the polished surface of the LT cross section or the LW cross section is observed with an SEM, and the total area of the voids with respect to the total area of the dielectric is measured in a range of about 10 μm×about 10 μm from the end of the end portion/side surface portion, and the porosity is calculated. When the porosity was about 3% or less, it was determined that the sample was acceptable (◯), and in other cases, it was determined that the sample was unacceptable (X).

### Test Method for Grain Growth/Sintered Particle Size

The sample was broken into five pieces such that the end portion/side surface portion of the LT cross section or the LW cross section was exposed. The above-described sample was heat-treated in order to clarify the boundary (grain boundary) between grains in the dielectric layer. The temperature of the heat treatment was a temperature at which grain growth did not occur and the grain boundary was clarified, and in the present experimental example, the treatment was performed at about 1,000° C.

The exposed grains of the dielectric layer were observed with a scanning electron microscope (SEM) at about 20,000 times. The visual field size was set to a region of about 6.3 μm×about 4.4 μm.

From the obtained SEM image, 300 grains were randomly extracted from each sample, the area of the inner portion of the grain boundary of each grain was determined by image analysis, and the equivalent circle diameter was calculated and adopted as the sintered particle size.

In a case of particles with the sintered particle size D99≤about 0.5 μm, it was determined to be acceptable (◯), and in other cases, it was determined to be unacceptable (X).

TABLE 1

| | Side surface side outer layer portion | | | | End surface side outer layer portion | | | | | |
|---|---|---|---|---|---|---|---|---|---|---|
| | | Mg increase | | | | Mg increase | | | | |
| | | amount | | | | amount | | | Moisture | |
| | | (increase | | | | (increase | | | resistance | Sintered |
| | | amount | | | | amount | | | reliability | particle |
| | (Ba/ | relative to | | | (Ba/ | relative to | | | MTTF of | size of |
| | Ti + | 100 parts by | | Grain | Ti + | 100 parts by | | Grain | 72 hours | 0.5 μm |
| | Zr) | mol of Ti) | Densification | growth | Zr) | mol of Ti) | Densification | growth | or more | or less |
| Example 1 | 1.002 | 0.50 | ○ | ○ | 1.002 | 0.25 | ○ | ○ | ○ | ○ |
| Example 2 | 1.002 | 1.50 | ○ | ○ | 1.002 | 0.75 | ○ | ○ | ○ | ○ |
| Example 3 | 1.002 | 2.50 | ○ | ○ | 1.002 | 1.25 | ○ | ○ | ○ | ○ |
| Example 4 | 1.002 | 3.50 | ○ | ○ | 1.002 | 1.75 | ○ | ○ | ○ | ○ |
| Example 5 | 1.002 | 5.00 | ○ | ○ | 1.002 | 2.50 | ○ | ○ | ○ | ○ |
| Example 6 | 0.995 | 0.50 | ○ | ○ | 0.995 | 0.25 | ○ | ○ | ○ | ○ |
| Example 7 | 0.995 | 5.00 | ○ | ○ | 0.995 | 2.50 | ○ | ○ | ○ | ○ |
| Example 8 | 1.003 | 0.50 | ○ | ○ | 1.003 | 0.25 | ○ | ○ | ○ | ○ |
| Example 9 | 1.003 | 5.00 | ○ | ○ | 1.003 | 2.50 | ○ | ○ | ○ | ○ |
| Comparative | 1.002 | 0.00 | x | ○ | 1.002 | 0.00 | x | ○ | x | ○ |
| Example 1 | | | | | | | | | | |
| Comparative | 1.002 | 0.40 | x | ○ | 1.002 | 0.20 | x | ○ | x | ○ |
| Example 2 | | | | | | | | | | |
| Comparative | 1.002 | 5.10 | x | x | 1.002 | 2.55 | ○ | ○ | x | x |
| Example 3 | | | | | | | | | | |
| Comparative | 0.994 | 0.00 | x | x | 0.994 | 0.00 | x | x | x | x |
| Example 4 | | | | | | | | | | |
| Comparative | 0.994 | 0.40 | x | x | 0.994 | 0.20 | x | x | x | x |
| Example 5 | | | | | | | | | | |
| Comparative | 0.994 | 5.00 | ○ | x | 0.994 | 2.50 | ○ | ○ | ○ | x |
| Example 6 | | | | | | | | | | |
| Comparative | 0.994 | 5.10 | × | ○ | 0.994 | 2.55 | ○ | ○ | x | ○ |
| Example 7 | | | | | | | | | | |
| Comparative | 1.004 | 0.00 | x | x | 1.004 | 0.00 | x | x | x | x |
| Example 8 | | | | | | | | | | |
| Comparative | 1.004 | 0.40 | x | x | 1.004 | 0.20 | x | x | x | x |
| Example 9 | | | | | | | | | | |
| Comparative | 1.004 | 5.00 | x | x | 1.004 | 2.50 | ○ | ○ | x | x |
| Example 10 | | | | | | | | | | |

TABLE 2

| | Side surface side outer layer portion | | | | End surface side outer layer portion | | | | | |
|---|---|---|---|---|---|---|---|---|---|---|
| | | Mg increase | | | | Mg increase | | | | |
| | | amount | | | | amount | | | Moisture | |
| | | (increase | | | | (increase | | | resistance | Sintered |
| | | amount | | | | amount | | | reliability | particle |
| | (Ba/ | relative to | | | (Ba/ | relative to | | | MTTF of | size of |
| | Ti + | 100 parts by | | Grain | Ti + | 100 parts by | | Grain | 72 hours | 0.5 μm |
| | Zr) | mol of Ti) | Densification | growth | Zr) | mol of Ti) | Densification | growth | or more | or less |
| Example 10 | 1.002 | 0.40 | ○ | ○ | 1.002 | 0.20 | ○ | ○ | ○ | ○ |
| Example 11 | 1.002 | 0.80 | ○ | ○ | 1.002 | 0.40 | ○ | ○ | ○ | ○ |
| Example 12 | 1.002 | 1.20 | ○ | ○ | 1.002 | 0.60 | ○ | ○ | ○ | ○ |
| Example 13 | 1.002 | 1.60 | ○ | ○ | 1.002 | 0.80 | ○ | ○ | ○ | ○ |
| Example 14 | 1.002 | 2.00 | ○ | ○ | 1.002 | 1.00 | ○ | ○ | ○ | ○ |
| Example 15 | 0.995 | 0.40 | ○ | ○ | 0.995 | 0.20 | ○ | ○ | ○ | ○ |
| Example 16 | 0.995 | 2.00 | ○ | ○ | 0.995 | 1.00 | ○ | ○ | ○ | ○ |
| Example 17 | 1.003 | 0.40 | ○ | ○ | 1.003 | 0.20 | ○ | ○ | ○ | ○ |
| Example 18 | 1.003 | 2.00 | ○ | ○ | 1.003 | 1.00 | ○ | ○ | ○ | ○ |
| Comparative | 1.002 | 0.00 | x | ○ | 1.002 | 0.00 | x | ○ | x | ○ |
| Example 11 | | | | | | | | | | |
| Comparative | 1.002 | 0.30 | x | ○ | 1.002 | 0.15 | x | ○ | x | ○ |
| Example 12 | | | | | | | | | | |
| Comparative | 1.002 | 2.10 | x | x | 1.002 | 1.05 | ○ | ○ | x | x |
| Example 13 | | | | | | | | | | |
| Comparative | 0.994 | 0.00 | x | x | 0.994 | 0.00 | x | x | x | x |
| Example 14 | | | | | | | | | | |
| Comparative | 0.994 | 0.40 | x | x | 0.994 | 0.20 | x | x | x | x |
| Example 15 | | | | | | | | | | |
| Comparative | 0.994 | 2.00 | ○ | x | 0.994 | 1.00 | ○ | ○ | ○ | × |
| Example 16 | | | | | | | | | | |
| Comparative | 0.994 | 2.10 | × | ○ | 0.994 | 1.05 | ○ | ○ | x | ○ |
| Example 17 | | | | | | | | | | |
| Comparative | 1.004 | 0.00 | x | x | 1.004 | 0.00 | x | x | x | x |
| Example 18 | | | | | | | | | | |
| Comparative | 1.004 | 0.40 | x | x | 1.004 | 0.20 | x | x | x | x |
| Example 19 | | | | | | | | | | |
| Comparative | 1.004 | 2.00 | x | x | 1.004 | 1.00 | x | x | x | x |
| Example 20 | | | | | | | | | | |

As shown in Table 1, in the case of including Mg, good results of moisture resistance reliability could be obtained in Examples 1 to 9.

That is, for example, at the center portion of the first side surface side outer layer portion WG1 or the second side surface side outer layer portion WG2 in the length direction L, in the dielectric in the region DW between the first side surface WS1 or the second side surface WS2 and the internal electrode layer 30, Ba/(Ti+Zr), which is the content ratio of Ba, Ti, and Zr, is about 0.995 or more and about 1.003 or less.

The content of Mg relative to 100 parts by mol of Ti is, for example, about 0.5 parts by mol to about 5.0 parts by mol larger than a content of Mg relative to 100 parts by mol of Ti in the dielectric which is in the region at the center portion in the width direction W and the length direction L of the effective portion 11.

In the first end surface side outer layer portion LG1 or the second end surface side outer layer portion LG2, the dielectric in the region DL between the first end surface LS1 or the second end surface LS2 and the internal electrode layer 30.

Ba/(Ti+Zr), which is the content ratio of Ba, Ti, and Zr, is, for example, about 0.995 or more and about 1.003 or less.

The content of Mg relative to 100 parts by mol of Ti is, for example, about 0.25 parts by mol to about 2.5 parts by mol larger than a content of Mg relative to 100 parts by mol of Ti in the dielectric which is in the region at the center portion in the width direction W and the length direction L of the effective portion 11, and accordingly, good results were obtained in the evaluation of moisture resistance reliability.

As shown in Table 2, in the case of including Mn, good results of moisture resistance reliability could be obtained in Examples 10 to 18.

That is, for example, at the center portion of the first side surface side outer layer portion WG1 or the second side surface side outer layer portion WG2 in the length direction L, in the dielectric in the region DW between the first side surface WS1 or the second side surface WS2 and the internal electrode layer 30, Ba/(Ti+Zr), which is the content ratio of Ba, Ti, and Zr, is about 0.995 or more and about 1.003 or less.

The content of Mn relative to 100 parts by mol of Ti is, for example, about 0.4 parts by mol to about 2.0 parts by mol larger than a content of Mn relative to 100 parts by mol of Ti in the dielectric which is in the region at the center portion in the width direction W and the length direction L of the effective portion 11.

In the first end surface side outer layer portion LG1 or the second end surface side outer layer portion LG2, the dielectric in the region DL between the first end surface LS1 or the second end surface LS2 and the internal electrode layer 30.

Ba/(Ti+Zr), which is the content ratio of Ba, Ti, and Zr, is, for example, about 0.995 or more and about 1.003 or less.

The content of Mn relative to 100 parts by mol of Ti is, for example, about 0.2 parts by mol to about 1.0 parts by mol larger than a content of Mn relative to 100 parts by mol of Ti in the dielectric which is in the region at the center portion in the width direction W and the length direction L of the effective portion 11, and accordingly, good results were obtained in the evaluation of moisture resistance reliability.

Corner side outer layer portions CG that are adjacent to the first side surface side outer layer portion WG1 or the second side surface side outer layer portion WG2 in the length direction L and are adjacent to the first end surface side outer layer portion LG1 or the second end surface side outer layer portion LG2 in the width direction W are positioned at four corners of the multilayer body 10 in plan view. Since this region is a region covered with the outer electrode 40 (FIGS. 3 and 4), the region is a portion where stress due to the deflection of the substrate is likely to be applied, the dielectric is likely to be cracked or chipped, and the multilayer ceramic capacitor is likely to be damaged. However, by improving the density of the dielectric in the predetermined region of the corner side outer layer portion CG, the mechanical strength can be improved, and the reliability of the multilayer ceramic capacitor can be improved.

For example, in the corner side outer layer portion CG, in the dielectric in the region DC surrounded by an imaginary surface obtained by extending in the width direction W a tip end surface of the internal electrode layer 30 opposite to the side to be connected to the outer electrode 40, an imaginary surface obtained by extending in the length direction L the side surface of the internal electrode layer 30, which extends in the length direction L, the first side surface WS1 or the second side surface WS2, and the first end surface LS1 or the second end surface LS2, when Ba/(Ti+Zr), which is a content ratio of Ba, Ti, and Zr, is about 0.995 or more and about 1.003 or less, and a content of Mg or Mn relative to 100 parts by mol of Ti is about 0.4 parts by mol to about 2.0 parts by mol larger than a content of Mg or Mn relative to 100 parts by mol of Ti in the dielectric which is in the region at the center portion in the width direction W and the length direction L of the effective portion 11, the porosity is about 3% or less, and grain growth can be achieved with a sintered particle size of about 0.5 μm or less, thus improving the density of the dielectric and increasing the mechanical strength, and effectively preventing damage such as cracks and chips in the multilayer ceramic capacitor.

In the first side surface side outer layer portion WG1 or the second side surface side outer layer portion WG2, it is suitable that the content of Mg or Mn increases in the dielectric which is in the region DW between the internal electrode layer 30 and the first side surface WS1 or between the internal electrode layer 30 and the second side surface WS2, in the direction from the internal electrode layer 30 to the first side surface WS or in the direction from the internal electrode layer 30 to the second side surface WS2. When the content of Mg or Mn increases, Mg or the like exists at the grain boundary portion, grain growth can be reduced or prevented, densification can be improved, and the grain diameter can be reduced. As a result, both moisture resistance reliability and reliability (reduction or prevention of generation of large particles) can be achieved. In addition, since the sintering temperature is different between the side surface and the inside during sintering, the content of Mg or the like increases toward the first side surface WS or the second side surface WS2, such that densification and reduction of variation in particle size can be achieved.

It is suitable that the internal electrode layer 30 has a structure in which, for example, in a range of about 5 μm from a terminal in the width direction W to a center in the width direction W, as shown in FIG. 7, an inclined surface where the thickness of the internal electrode layer 30 in the lamination direction T gradually decreases toward the terminal is formed, and in which the dielectric 20a in which the particle size of all grains is about 500 nm or less is laminated on the inclined surface. In this manner, by disposing the dense dielectric on the side surface of the internal electrode layer 30, moisture that has infiltrated from the outside can be prevented from reaching the internal electrode layer, and high moisture resistance reliability can be achieved.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including dielectric layers and internal electrode layers that are laminated; and
an outer electrode to be electrically connected to the internal electrode layers; wherein
the dielectric layers include Ba, Ti, and Zr, and Mg or Mn;
the multilayer body includes a first main surface and a second main surface opposite to each other in a lamination direction of the dielectric layers and the internal electrode layers, a first side surface and a second side surface opposite to each other in a width direction intersecting both the lamination direction and a length direction in which the internal electrode layers extend to the outer electrode, and a first end surface and a second end surface opposite to each other in the length direction;
the outer electrode is provided on each of the first end surface and the second end surface;
in the multilayer body, a region in which the internal electrode layers overlap each other as viewed in the lamination direction is defined as an effective portion, regions opposite to each other in the lamination direction with the effective portion therebetween are defined as a first main surface side outer layer portion and a second main surface side outer layer portion, regions opposite to each other in the width direction with the effective portion therebetween are defined as a first side surface side outer layer portion and a second side surface side outer layer portion, and regions opposite to each other in the length direction with the effective portion therebetween are defined as a first end surface side outer layer portion and a second end surface side outer layer portion;
at a center portion of the first side surface side outer layer portion or the second side surface side outer layer portion in the length direction, in a dielectric in a region between the first side surface or the second side surface and one of the internal electrode layers Ba/(Ti+Zr), which is a content ratio of Ba, Ti, and Zr, is about 0.995 or more and about 1.003 or less, and a content of Mg relative to 100 parts by mol of Ti is about 0.5 parts by mol to about 5.0 parts by mol larger than a content of Mg relative to 100 parts by mol of Ti in a dielectric which is in a region at a center portion in the width direction and the length direction of the effective portion, or a content of Mn relative to 100 parts by mol of Ti is about 0.4 parts by mol to about 2.0 parts by mol larger than a content of Mn relative to 100 parts by mol of Ti in the dielectric which is in the region at the center portion in the width direction and the length direction of the effective portion; and
in the first end surface side outer layer portion or the second end surface side outer layer portion, in a dielectric in a region between the first end surface or the second end surface and one of the internal electrode layers, Ba/(Ti+Zr), which is a content ratio of Ba, Ti, and Zr, is about 0.995 or more and about 1.003 or less, and a content of Mg relative to 100 parts by mol of Ti is about 0.25 parts by mol to about 2.5 parts by mol larger than the content of Mg relative to 100 parts by mol of Ti in the dielectric which is in the region at the center portion in the width direction and the length direction of the effective portion, or a content of Mn relative to 100 parts by mol of Ti is about 0.2 parts by mol to about 1.0 parts by mol larger than the content of Mn relative to 100 parts by mol of Ti in the dielectric which is in the region at the center portion in the width direction and the length direction of the effective portion.

2. The multilayer ceramic capacitor according to claim 1, wherein
a region adjacent to the first side surface side outer layer portion or the second side surface side outer layer portion in the length direction and adjacent to the first end surface side outer layer portion or the second end surface side outer layer portion in the width direction is defined as a corner side outer layer portion;
in the corner side outer layer portion, in a dielectric in a region surrounded by an imaginary surface obtained by extending in the width direction a tip end surface of one of the internal electrode layers opposite to a side to be connected to an outer electrode, an imaginary surface obtained by extending in the length direction a side surface of the one of internal electrode layers, which extends in the length direction, the first side surface or the second side surface, and the first end surface or the second end surface, Ba/(Ti+Zr), which is a content ratio of Ba, Ti, and Zr, is about 0.995 or more and about 1.003 or less, and a content of Mg or Mn relative to 100 parts by mol of Ti is about 0.4 parts by mol to about 2.0 parts by mol larger than the content of Mg or the content of Mn relative to 100 parts by mol of Ti in the dielectric which is in the region at the center portion in the width direction and the length direction of the effective portion.

3. The multilayer ceramic capacitor according to claim 1, wherein, in the first side surface side outer layer portion or the second side surface side outer layer portion, in a dielectric in a region between one of the internal electrode layers and the first side surface or between another one of the internal electrode layers and the second side surface, a content of Mg or Mn increases in a direction from the one of the internal electrode layers to the first side surface or in a direction from the another one of the internal electrode layers to the second side surface.

4. The multilayer ceramic capacitor according to claim 1, wherein
at least one of the internal electrode layers includes an inclined surface in a range of about 5 μm from a terminal in the width direction to a center in the width direction;
a thickness of the at least one of the internal electrode layers in the lamination direction gradually decreases toward the terminal in the inclined surface; and
a particle size of all grains is about 500 nm or less in a dielectric laminated on the inclined surface.

5. The multilayer ceramic capacitor according to claim 1, wherein
a dimension of the multilayer body in the length direction is about 0.2 mm or more and about 10 mm or less;
a dimension of the multilayer body in the lamination direction is about 0.1 mm or more and about 10 mm or less; and
a dimension of the multilayer body in the width direction is about 0.1 mm or more and about 10 mm or less.

6. The multilayer ceramic capacitor according to claim 1, wherein a thickness of each of the dielectric layers is about 0.5 μm or more and about 72 μm or less.

7. The multilayer ceramic capacitor according to claim 1, wherein a number of the dielectric layers is 10 or more and 700 or less.

8. The multilayer ceramic capacitor according to claim 1, wherein each of the internal electrode layers includes Ni, Cu, Ag, Pd, or Au, or an alloy including at least one of Ni, Cu, Ag, Pd, or Au.

9. The multilayer ceramic capacitor according to claim 1, wherein a thickness of each of the internal electrode layers is about 0.2 μm or more and about 3.0 μm or less.

10. The multilayer ceramic capacitor according to claim 1, wherein a number of the internal electrode layers is 5 or more and 350 or less.

11. The multilayer ceramic capacitor according to claim 1, wherein the outer electrode includes a base electrode layer and a plating layer on the base electrode layer.

12. The multilayer ceramic capacitor according to claim 11, wherein the base electrode layer includes a metal component and a glass component.

13. The multilayer ceramic capacitor according to claim 12, wherein the metal component includes at least one of Cu, Ni, Ag, Pd, Au, or an alloy of Ag and Pd.

14. The multilayer ceramic capacitor according to claim 12, wherein the plating layer includes at least one of Cu, Ni, Ag, Pd, Au, or an alloy of Ag and Pd.

15. The multilayer ceramic capacitor according to claim 12, wherein the plating layer includes a Ni plating layer and a Sn plating layer.
